(19) United States
(12) Patent Application Publication
(10) Pub. No.: US 2015/0055458 A1
(43) Pub. Date: Feb. 26, 2015

(54) VIDEO TRANSMISSION DEVICE, VIDEO TRANSMISSION METHOD, AND PROGRAM

(71) Applicant: SONY CORPORATION, Tokyo (JP)

(72) Inventors: Kensaku Wakuda, Kanagawa (JP); Tomoya Oikawa, Tokyo (JP)

(73) Assignee: SONY CORPORATION, Tokyo (JP)

(21) Appl. No.: 14/378,806

(22) PCT Filed: Feb. 8, 2013
(86) PCT No.: PCT/JP2013/053082

§ 371 Date: Aug. 14, 2014

(30) Foreign Application Priority Data
Feb. 21, 2012 (JP) 2012-035071

(51) Int. Cl. H04L 12/825; H04N 19/146; H04L 12/18

(52) U.S. Cl. CPC H04L 47/25; H04L 12/18; H04N 19/146
USPC 370/230; 375/240.02

(57) ABSTRACT

Provided is a video transmission device including an encoding unit configured to encode video data, a transfer rate setting unit configured to set a transfer rate of a physical layer based on an encoding rate of the encoded video data, and a transmission unit configured to transmit the encoded video data at the transfer rate.

### TECHNICAL FIELD

The present disclosure relates to a video transmission device, a video transmission method, and a program.

### BACKGROUND ART

In recent years, data communication via the Internet has been actively performed. Furthermore, a home network that connects home appliances, computers, and other peripheral devices in a network continues to enter more households. Such a home network enables content transmission and reception between, for example, network connected devices, and thus is expected to become more and more widespread.

A data distribution process in which video data retained in a server is transmitted to a client via a network and the data is reproduced while the client executes reception of the data is called streaming data distribution or data streaming. A server that performs such streaming data distribution is called a streaming server, and a client that receives data from the streaming server is called a streaming client. The streaming server is a video transmission device that generates transmission data by executing data processing that includes encoding and outputs the data to a network. On the other hand, the streaming client is a video reception device which temporarily stores received data in a buffer and sequentially performs a decoding process and reproduction.

In such streaming data distribution, performing data distribution at an optimum transfer rate is important. When the transfer rate is not appropriately controlled, there are cases in which a delay of transfer occurs, packets are lost, and the like. In video and audio streaming data distribution, for example, such a problem leads to disarray of videos and interruption of sound.

Thus, for example, Patent Literature 1 discloses a method in which a connection speed is sampled a plurality of times over a certain period and then resolution of an image and an encoding rate are set with reference to a table based on the average value of the connection speed.

### CITATION LIST

### Patent Literature

Patent Literature 1: JP 2007-329814A

### SUMMARY OF INVENTION

### Technical Problem

It is, however, difficult to apply the method described above to multicast for performing one-to-many communication. This is because it is hard for a video transmission device in multicast to acquire information such as a loss rate at the time of transfer, the number of times of re-transmission, or an SNR.

Considering the above-described circumstances, it is desirable to provide a video transmission device, a video transmission method, and a program that can also be applied to multicast communication and can perform data distribution at an optimum transfer rate.

### Solution to Problem

According to the present disclosure, a video transmission device which has an encoding unit that encodes video data, a transfer rate setting unit that sets a transfer rate of a physical layer based on an encoding rate of the encoded video data, and a transmission unit that transmits the encoded video data at the transfer rate is provided.

According to the configuration, a transfer rate of a physical layer is set based on an encoding rate. For this reason, it is possible to reduce a possibility of occurrence of a delay, loss of packets, and the like caused by mismatch between transfer rates set in protocol stacks.

In addition, according to the present disclosure, a video transmission method that includes encoding video data, setting a transfer rate of a physical layer based on an encoding rate of the encoded video data, and transmitting the encoded video data at the transfer rate is provided.

In addition, according to the present disclosure, a program for causing a computer to function as a video transmission device that has an encoding unit that encodes video data, a transfer rate setting unit that sets a transfer rate of a physical layer based on an encoding rate of the encoded video data, and a transmission unit that transmits the encoded video data at the transfer rate is provided.

### Advantageous Effects of Invention

According to the present disclosure described above, a video transmission device, a video transmission method, and a program that can also be applied to multicast communication and can perform data distribution at an optimum transfer rate are provided.

### BRIEF DESCRIPTION OF DRAWINGS

FIG. 1 is a protocol stack diagram of a video transmission device according to an embodiment of the present disclosure.

FIG. 2 is a block diagram showing a functional configuration of a video transfer system according to an embodiment of the present disclosure.

FIG. 3 is a block diagram showing a detailed configuration of a rate control unit of the video transmission device according to the same embodiment.

FIG. 4 is a descriptive diagram showing a configuration example of an IP packet transmitted by the video transmission device according to the same embodiment.

FIG. 5 is a descriptive diagram for describing an overview of the IEEE 802.11a standard used by the video transmission device according to the same embodiment.

FIG. 6 is a table showing an example of options of a physical transfer rate set by the video transmission device according to the same embodiment.

FIG. 7 is an example of a correspondence table of physical transfer rates and encoding rates used by the video transmission device according to the same embodiment.

FIG. 8 is a descriptive diagram showing an overview of a data frame configuration used by the video transmission device according to the same embodiment.

FIG. 9 is a descriptive diagram showing details of the data frame configuration used by the video transmission device according to the same embodiment.

FIG. 10 is a flowchart for describing a physical transfer rate setting process performed in the video transmission device according to the same embodiment.

FIG. 11 is a descriptive diagram showing a configuration of an ACK packet transferred in a video transfer system according to a second embodiment of the present disclosure.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Note that description will be provided in the following order.

1. Overview

2. First embodiment (An example in which a transfer rate of a physical layer is set based on an encoding rate)
2-1. Functional configuration
2-2. Setting of a physical transfer rate

3. Second embodiment (An example in which a transfer rate is re-set based on the number of times of re-transmission)
3-1. Setting of a physical transfer rate
3-2. Setting of an encoding rate

4. Conclusion

### 1. OVERVIEW

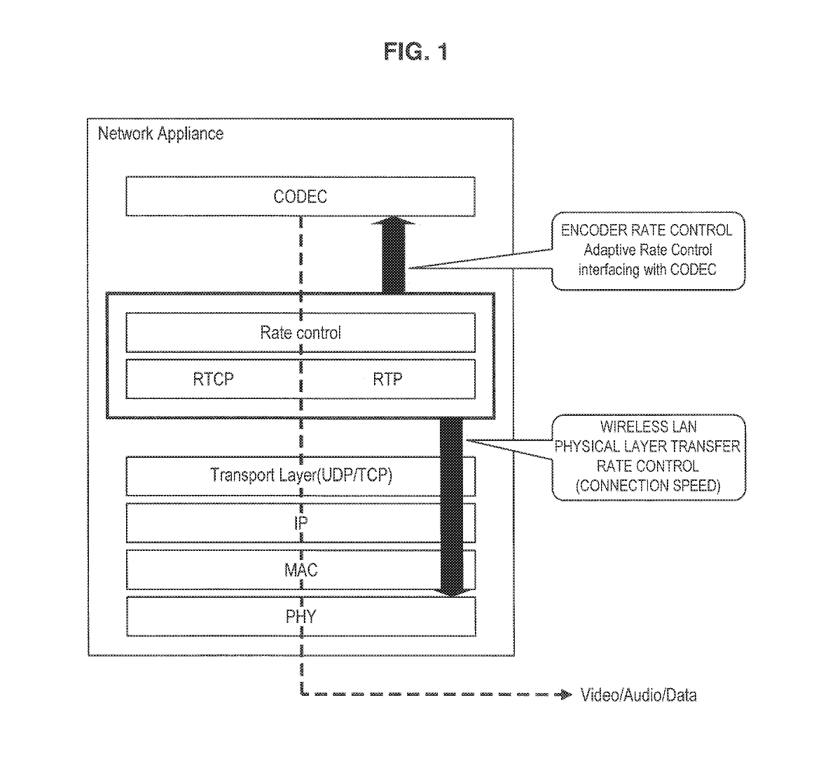

First, an overview of the present disclosure will be described. Note that FIG. 1 will be referred to for description. FIG. 1 is a protocol stack diagram of a video transmission device according to an embodiment of the present disclosure.

As described above, a system for transferring a video from a streaming server to a streaming client through streaming data distribution has widely proliferated in recent years. A communications protocol which is used in most streaming data distribution is an RTP (Realtime Transport Protocol). The RTP does not perform re-transmission control in principle. The RTP is a protocol of a UDP (User Datagram Protocol) type that does not counter packet loss and assure a transfer time. Since such an RTP does not perform a re-transmission process even when packet loss occurs, it is a protocol suitable for real-time reproduction without causing a delay resulting from the re-transmission process.

In communication to which the RTP is applied, for example, rates are controlled in levels of transport layers using an RTCP (RTP Control Protocol). On the other hand, in a transfer system using a wireless LAN (Local Area Network), as rate control (connection speed control) algorithms used in a physical layer. ONOE, SampleRate, and the like are exemplified. The rate control algorithms are algorithms for controlling a transfer rate based on a loss rate at the time of transfer, the number of times of re-transmission, and the like. In addition, there are other algorithms for deciding a transfer rate using an SNR (Signal-Noise Ratio).

When a mismatch is made between rate control in the level of a transport layer (RTP) and rate control in the level of a physical layer, RTP packets are accumulated in a transmission buffer, which leads to occurrence of a delay and loss of packets overflowing in the buffer.

Thus, the present disclosure proposes setting of a transfer rate of a physical layer based on an encoding rate. Cross-layer-associated rate control in which the encoding rate and the transmission rate of a physical layer are simultaneously decided can also be performed. Accordingly, enhancement of transfer efficiency, a decrease in packet loss, a reduction of a delay in buffering, and enhancement of QoE (Quality of Experience) are expected.

In addition, the method of setting a transfer rate of a physical layer based on an encoding rate is advantageous in that it can also be applied to a system of performing multicast transfer. For example, in a system of performing unicast transfer, in order to solve a mismatch of rate control between layers, monitoring a connection speed of a physical layer and controlling an encoding rate of a video based on the actual connection speed of the physical layer can be considered. It is, however, difficult to apply this method to the system of performing multicast transfer. This is because, in multicast transfer, it is difficult to perform rate control in a physical layer without acquiring information of a loss rate at the time of transfer, the number of times of re-transmission, an SNR, and the like due to communication performed among a plurality of terminals at once. Thus, in wireless LAN multicast, transfer is performed at a fixed rate and a mismatch can occur between a transfer rate of a transport layer and a transfer rate of a physical layer.

FIG. 1 shows a protocol stack diagram of the video transfer device according to an embodiment of the present disclosure. As shown herein, based on an encoding rate of a CODEC, a transfer rate of a physical layer is set, and encoded content data (including video data and audio data) is transferred at the set transfer rate. Such a video transfer device will be described next exemplifying exemplary embodiments.

### 2. FIRST EMBODIMENT

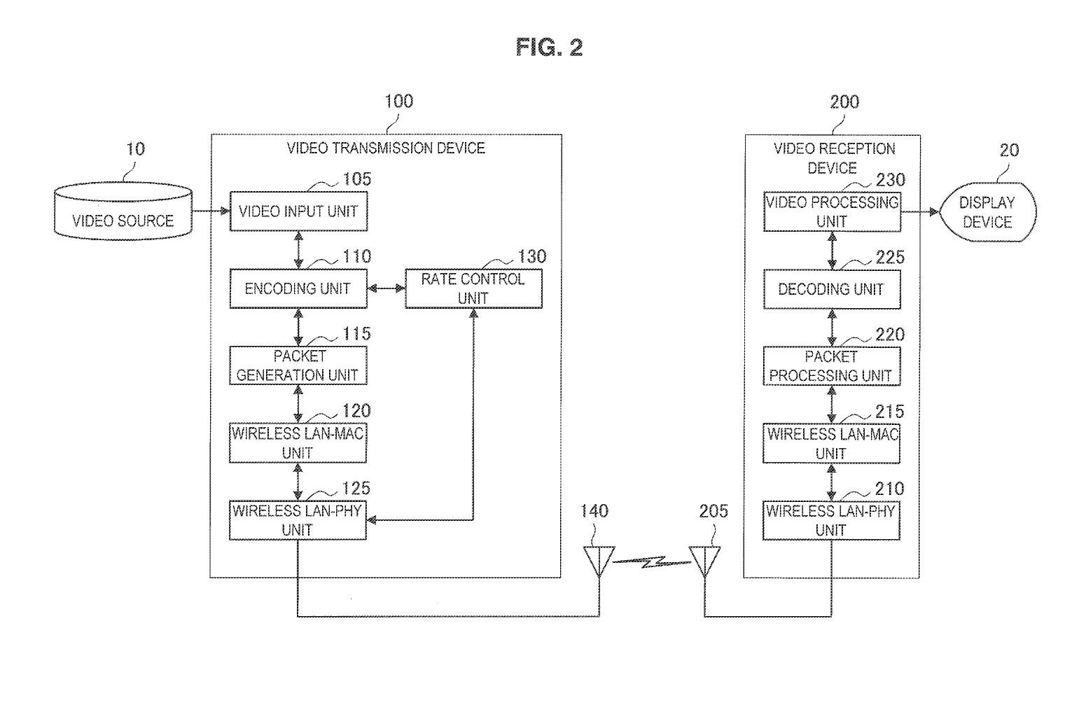

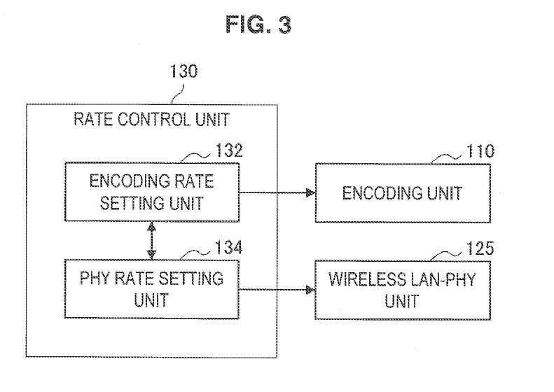

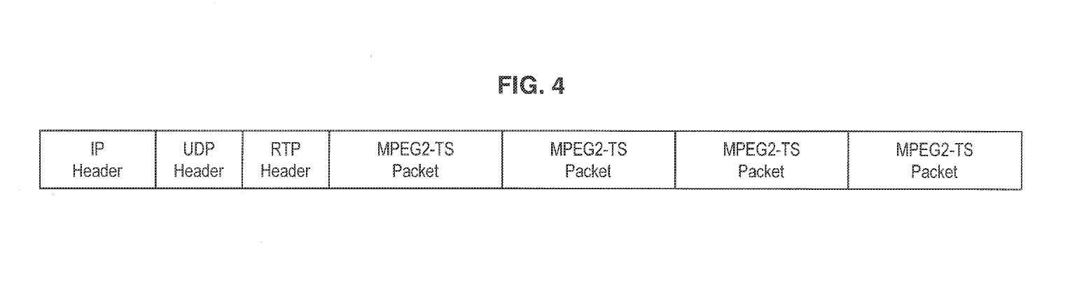

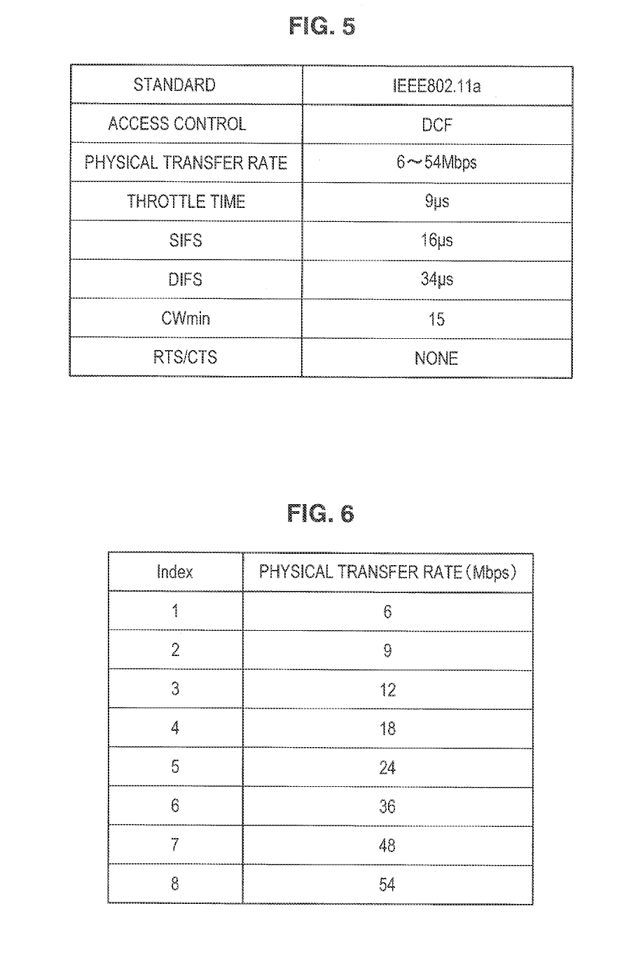

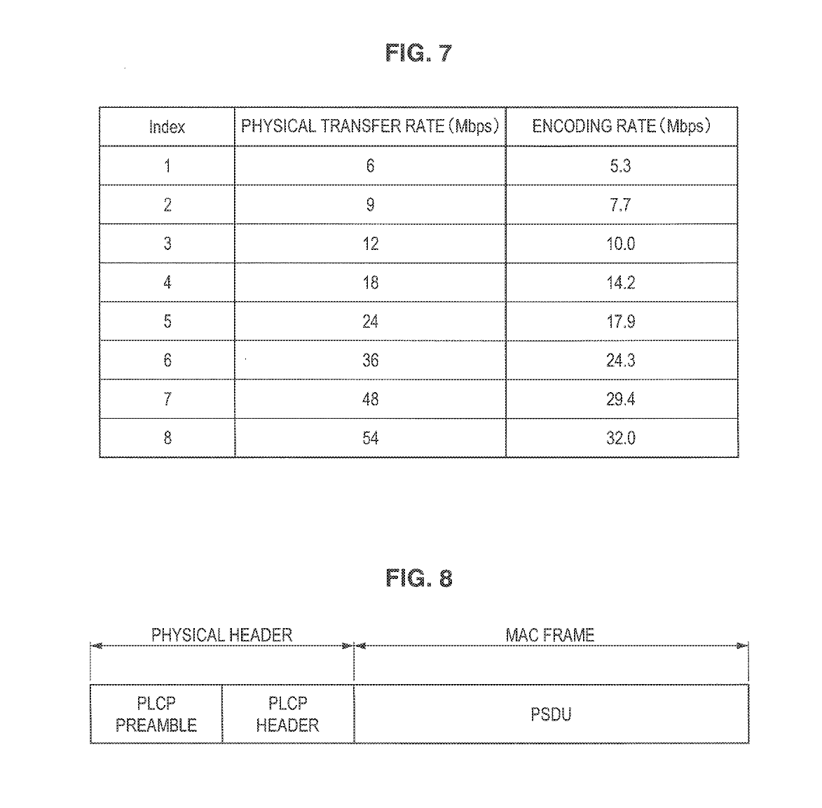

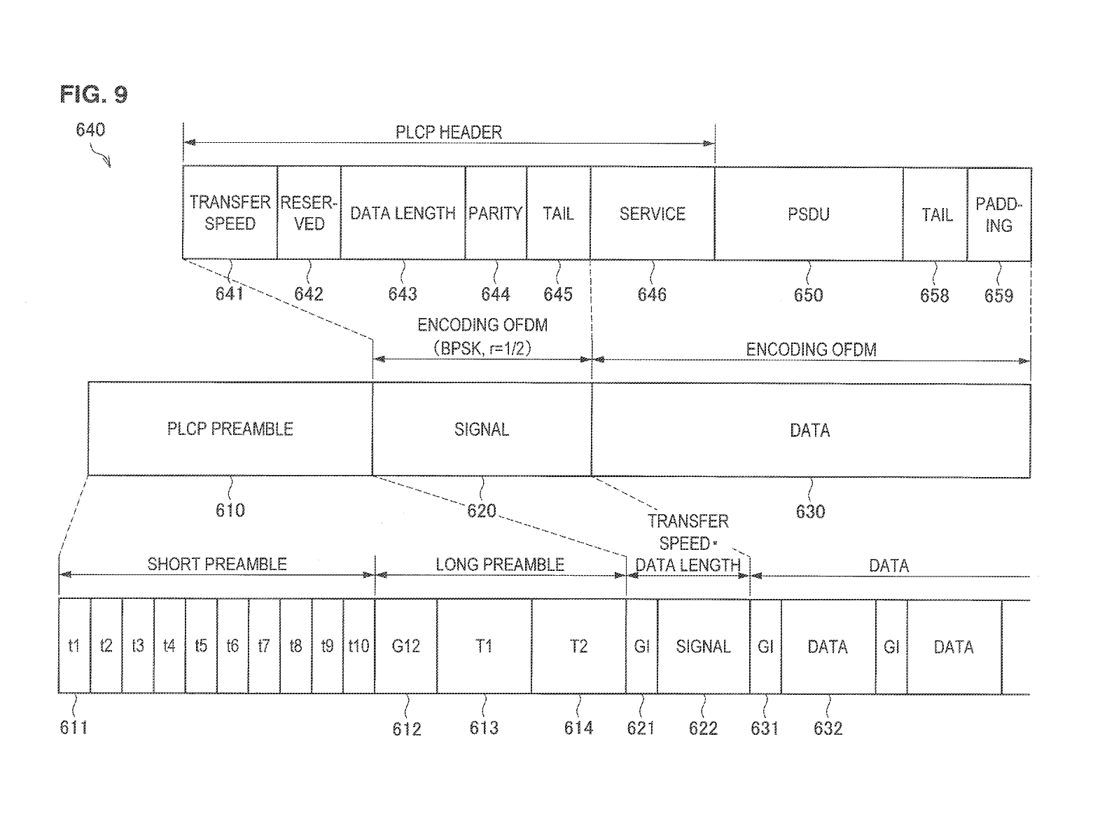

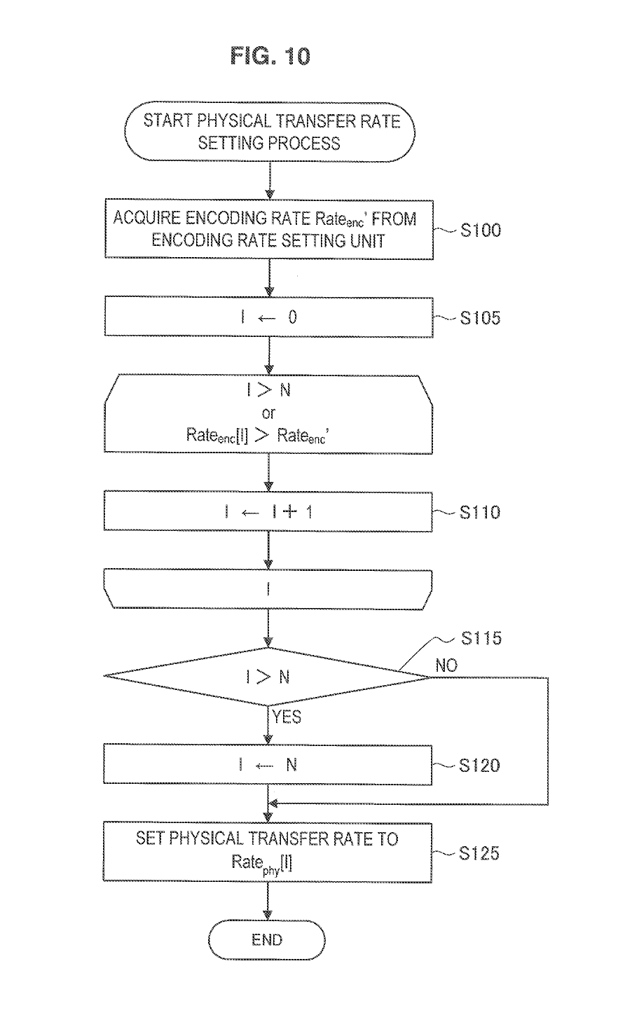

Next, a video transfer system 1 according to a first embodiment of the present disclosure will be described with reference to FIGS. 2 to 10. FIG. 2 is a block diagram showing a functional configuration of the video transfer system according to the embodiment of the present disclosure. FIG. 3 is a block diagram showing a detailed configuration of a rate control unit of the video transmission device according to the same embodiment. FIG. 4 is a descriptive diagram showing a configuration example of an IP packet transmitted by the video transmission device according to the same embodiment. FIG. 5 is a descriptive diagram for describing an overview of the IEEE 802.11a standard used by the video transmission device according to the same embodiment. FIG. 6 is a table showing an example of options of a physical transfer rate set by the video transmission device according to the same embodiment. FIG. 7 is an example of a correspondence table of physical transfer rates and encoding rates used by the video transmission device according to the same embodiment. FIG. 8 is a descriptive diagram showing an overview of a data frame configuration used by the video transmission device according to the same embodiment. FIG. 9 is a descriptive diagram showing details of the data frame configuration used by the video transmission device according to the same embodiment. FIG. 10 is a flowchart for describing a physical transfer rate setting process performed in the video transmission device according to the same embodiment.

### [2-1. Functional Configuration]

Referring to FIG. 2, the video transfer system 1 according to the embodiment of the present disclosure includes a video transmission device 100 and a video reception device 200. The video transmission device 100 acquires a video from a video source 10 and transmits video data to the video reception device 200 through wireless communication. After performing various processes on the received video data, the video reception device 200 can output the data to a display device 20. Note that the video source 10 here may be, for example, a storage device or a moving image capturing device. The video transmission device 100 can transmit video data stored in the storage device or live video data from the moving image capturing device to the video reception device 200 via a wireless transfer line. Note that, in description provided below, encoding and packetizing using MPEG2-TS (Transport Steam) over IP are exemplified, but any other codec may be used.

The video transmission device 100 mainly has a video input unit 105, an encoding unit 110, a packet generation unit 115, a wireless LAN-MAC unit 120, a wireless LAN-PHY unit 125, a rate control unit 130, and a wireless antenna 140. In addition, when FIG. 3 is referred to, the rate control unit 130 further has an encoding rate setting unit 132 and a PHY rate setting unit 134. The video reception device 200 mainly has a wireless antenna 205, a wireless LAN-PHY unit 210, a wireless LAN-MAC unit 215, a packet processing unit 220, a decoding unit 225, and a video processing unit 230.

### (Video Transmission Device 100)

The video input unit 105 captures a video frame from the video source 10 and supplies video data to the encoding unit 110 as digital data. The encoding unit 110 encodes the supplied video data at an encoding rate designated by the rate control unit 130. The encoding unit 110 can supply the encoded video data to the packet generation unit 115.

The packet generation unit 115 generates MPEG2-TS packets, and aggregates a plurality of MPEG2-TS packets to make the packets as an IP packet. As shown in FIG. 4, for example, the packet generation unit 115 can aggregate the plurality of MPEG2-TS packets and then make the packets as an IP packet by adding an RTP header (12 bytes), a UDP header (8 bytes), and an IP header (20 bytes). For example, an MPEG2-TS packet is basically generated in a unit of 188 bytes. For this reason, when a maximum packet length is set to 1500 bytes, there are [(1500-20-8-12)/188]=7 packets. The packet generation unit 115 at this time can aggregate 7 MPEG2-TS packets. When 7 MPEG2-TS packets are aggregated, the IP packet length is 1356 bytes.

Note that the packet generation unit 115 is set to generate the MPEG2-TS packets and perform IP-packetizing here, but the present technology is not limited thereto. For example, the encoding unit 110 may encode the video data and generate the MPEG2-TS packets. In this case, the packet generation unit 115 can aggregate the MPEG2-TS packets supplied from the encoding unit 110 to perform IP packetizing.

The video transmission device 100 transfers the IP packet generated as described above to the video reception device 200 using wireless LAN transfer. The wireless LAN-MAC unit 120 provides a MAC sublayer based on the wireless LAN standard of the IEEE 802.11. The wireless LAN-MAC unit 120 mainly has a function of adding a MAC header to the IP packet and performing access control using CSMA/CA (Carrier Sense Multiple Access/Collision Avoidance)

The wireless LAN-PHY unit 125 adds a PLCP (Physical Layer Convergence Protocol) preamble header to the MAC frame supplied from the wireless LAN-MAC unit 120, and supplies a packet digitally modulated with OFDM (Orthogonal Frequency-Division Multiplexing) or the like to the wireless antenna 140. The wireless LAN-PHY unit 125 at this time uses the transfer rate designated by the rate control unit 130.

The rate control unit 130 has the encoding rate setting unit 132 that sets an encoding rate of the encoding unit 110 and the PHY rate setting unit 134 that sets a transfer rate in the level of a physical layer of the wireless LAN-PHY unit 125 based on an actual encoding rate of encoded data encoded by the encoding unit 110. The encoding rate setting unit 132 decides an encoding rate using, for example, TFRC (TCP Friendry Rate Control) widely used in transfer of RTP, and supplies the encoding rate to the encoding unit 110. In addition, the encoding rate setting unit 132 observes the current encoding rate of encoded data output from the encoding unit 110, and then supplies the observed encoding rate to the PHY rate setting unit 134. The PHY rate setting unit 134 computes an appropriate PHY rate based on the supplied encoding rate, and supplies the rate to the wireless LAN-PHY unit 125. The method of the PHY rate setting unit 134 for computing the appropriate transfer rate here will be described later in detail.

### (Video Reception Device 200)

The wireless antenna 205 receives the packet transmitted from the video transmission device 100. Then, the wireless antenna 205 supplies the received packet to the wireless LAN-PHY unit 210. The IP packet of which the MAC header has been removed through the wireless LAN-PHY unit 210 and the wireless LAN-MAC unit 215 is supplied to the packet processing unit 220.

The packet processing unit 220 takes out the aggregated TS packets from the received IP packet and then supplies the packets to the decoding unit 225 as MPEG2 data. The decoding unit 225 decodes the MPEG2 data into video frames and then supplies the frames to the video processing unit 230. The video processing unit 230 outputs the video frames to the display device 20 in accordance with a vertical synchronization signal of the display device 20.

### [2-2. Decision of a Physical Transfer Rate]

Next, a method of a rate control unit 130a of the video transmission device 100a according to the first embodiment of the present disclosure for deciding a transfer rate of a physical layer will be described with reference to FIGS. 5 to 9.

### (Overview)

Herein, a case in which the wireless LAN standard of IEEE 802.11a for the specifications shown in FIG. 5 is used as a physical layer will be described. The standard of IEEE 802.11a is a set of standards made by the working group of the 802 standard committee of IEEE (Institute of Electrical and Electronics Engineers in US). In addition, a case in which the one-to-many multicast transfer scheme is used will be discussed and re-transmission of a packet is assumed not to be performed.

As shown in FIG. 5, the standard of IEEE 802.11a uses DCF (Distributed Coordination Function) in access control. The DCF is an access control function through autonomous distributed control, and uses the CSMA/CA access scheme for deciding whether or not transmission is performed according to a state in which a wireless channel is used. The standard of IEEE 802.11a can use a physical transfer rate of 6 to 54 Mbps. In addition, a throttle time is 9 μs, an SIFS (Short Inter Frame Space) is 16 μs, and a DIFS (Distributed Inter Frame Space) is 34 μs. In addition, CWmin (the minimum value of a contention window size) is 15, and RTS/CTS is not used.

For example, the wireless LAN-PHY unit 125 can set any physical transfer rate of 6 to 54 Mbps by designating any index from 1 to 6 as shown in FIG. 6. In this case, a table showing encoding rates corresponding to each index is generated as shown in FIG. 7, and the PHY rate setting unit 134 can select a physical transfer rate corresponding to an actual encoding rate using this table and gives a notification to the wireless LAN-PHY unit 125.

A calculation method for generating Table 7 that is a correspondence table of physical transfer rates and encoding rates used to set the physical transfer rates based on the encoding rate as described above will be described next.

### (Data Frame Configuration)

A data frame configuration of the standard of IEEE 802.11a used as an example herein is shown in FIGS. 8 and 9. As shown in FIG. 8, a data frame mainly includes a physical header and a MAC frame. The physical header includes a PLCP preamble and a PLCP header. The PLCP preamble is a bit string of a synchronization signal added to the head of an IEEE 802.11 frame, and added to a physical layer. In addition, the PLCP header is a header that includes information such as a modulation scheme, a data length, and the like, and added to the physical layer. In addition, a PSDU (PLCP Service Data Unit) that is the MAC frame is information constituted by an IEEE 802.11 header and actual data, and added to a data link layer.

In addition, the more detailed configuration of the data frame will be described with reference to FIG. 9. The data frame 640 based on the standard of IEEE 802.11a includes the PLCP preamble 610, a signal 620, and data 630. The PLCP preamble 610 is a fixed pattern signal for a reception synchronization process of a wireless packet signal. The signal 620 is an OFDM symbol that includes a transfer speed and a data length of the data 630. The data 630 is a field that includes the main body of information data.

When a logical field is focused, the signal 620 is constituted by a transfer speed 641 of 4 bits, a reserved bit 642 of 1 bit, a data length 643 of 12 bits, a parity 644 of 1 bit, and a tail 645 of 6 bits that terminates convolutional coding of the above data. Both the transfer speed 641 and the data length 643 are information relating to the data 630. The signal 620 itself is transferred through BPSK (Binary Phase Shift Keying) modulation of a transfer speed of 6 Mbps with high reliability, i.e., an encoding rate of ½.

The data 630 includes a service 646 of 16 bits and a variable-length data PSDU (PLCP Service Data Unit) 650. Furthermore, the data 630 is constituted by a tail 658 of 6 bits that terminates convolutional coding of the above data and a padding bit 659 that fills surplus bits of the OFDM symbol. The data PSDU 650 stores information relating to a frame control field in the MAC frame, an address field, a frame body field, and the like. Note that the service 646 is constituted by “0” of 7 bits for giving an initial state of a scrambler and a reserved bit of 9 bits. In addition, each field of the signal 620 and the service 646 constitute the PLCP header 640.

When a physical signal in a frame is focused, the PLCP preamble 610 is constituted by a short preamble that includes 10 short training symbols 611 and a long preamble that includes two long training symbols 613 and 614. The short preamble is a fixed pattern signal defined by a cycle of 0.8 μs using sub-carriers of 12 waves, forming a signal of a total of 8.0 μs in 10 cycles of t1 to t10. The short preamble is used in detection of a packet signal, amplification of a signal, rough adjustment of a carrier frequency error, detection of a symbol timing and the like in a PMD unit 340.

On the other hand, the long preamble is a repetitive signal of two symbols using sub-carriers of 52 waves, forming a signal of a total of 8.0 μs by two long training symbols 613 and 614 of 3.2 μs following a guard interval 612 of 1.6 μs. The long preamble is used in fin adjustment of a carrier frequency error, estimation of a channel, detection of a basic amplitude and a basic phase of each sub-carrier in the PMD unit 340.

In the signal 620, a guide interval 621 of 0.8 μs is added before the main body of a signal 622 of 3.2 μs, forming a signal of a total of 4 μs. In addition, also in the data 630, a signal of a total of 4 μs obtained by adding a guard interval 631 of 0.8 μs before the main body of data 632 of 3.2 μs is repeated according to the data length 643.

### (Generation of a Correspondence Table)

The calculation method for generating Table 7 that is a correspondence table of physical transfer rates and encoding rates used to set the physical transfer rates based on the encoding rate will be described next, exemplifying the data frame structure described above.

First, a PLCP transfer time is computed as below.

PLCP transfer time=PLCP preamble transfer time+PLCP header transfer time=16 (μs)+8 (μs)=20 (μs)

Next, the frame length is computed as below.

$$\begin{matrix}Frame length = M A C header length + L L C header length + \\ IP packet length + F C S length + P L C P tail bit \\ = 24 + 8 + 1356 + 4 + 6 \\ = 1392 ( byte )\end{matrix}$$

Note that LLC here is an abbreviation for Logical Link Control. In addition, FCS is an abbreviation for Frame Check Sequence.

$$Frame transfer time = [ \frac{Frame length}{Physical transfer rate} + O F D M symbol length ] \times O F D M symbol length \qquad Expression ( 1 )$$

As described above, the frame transfer time is calculated with addition of the padding bit so as to be an integral multiple of the OFDM symbol length (4 μs).

A frame interval is as described below.

$$\begin{matrix}Frame interval = DIFS + Average back \text{-} off time \\ = DIFS + {CW}_{min} \times Throttle time / 2 \\ = 34 + 15 \times 9 / 2 \\ = 101.5 ( μ s )\end{matrix}$$

Thus, a TS packet effective rate is calculated as follows.

$$T S packet effective rate = \frac{T S packet length \times Number of TS packets}{\begin{matrix}P L C P transfer time + Frame transfer time + \\ Frame interval\end{matrix}} \qquad Expression ( 2 )$$

In Expression (2), when the TS packet effective rate is set to be an encoding rate, encoding rates corresponding to each of physical transfer rates are computed by using Expression (1), Expression (2), the value of the PLCP transfer time computed as described above, and the value of the frame interval, and thereby the correspondence table as shown in FIG. 7 can be generated.

Note that, when the padding bit is ignored, a physical transfer rates can also be obtained from the TS packet effective rate with Expression (3).

$$Physical transfer rate = \frac{Frame length}{\begin{matrix}\frac{TS packet length \times Number of TS packets}{TS packet effective rate} - \\ P L C P transfer time - Frame interval\end{matrix}} \qquad Expression ( 3 )$$

### Operation Example

Herein, an operation example of a physical transfer rate setting process will be described with reference to FIG. 10. Here, I represents the value of an index having a value of 1 to 8. In addition, N represents the final value of the index, which is 8 herein. In addition, Rateₑₙₑ[I] represents an encoding rate corresponding to a physical transfer rate shown in the correspondence table. Rateₑₙₑ′ represents a current actual encoding rate, and Rate_{phy}[I] represents a physical transfer rate of the correspondence table.

First, the PHY rate setting unit 134 acquires the current encoding rate Rateₑₙₑ′ from the encoding rate setting unit 132 (S100). Next, the PHY rate setting unit 134 resets the value of I to 0 (S105). Then, with reference to the correspondence table, the value of I is increased until the value of the encoding rate Rateₑₙₑ[I] at the set value of I exceeds the value of the actual encoding rate Rateₑₙₑ′ or the value of I exceeds N (=8) (S110).

Then, when the condition of I>N or Rateₑₙₑ[I]<Rateₑₙₑ′ is satisfied, the PHY rate setting unit 134 then determines whether or not I>N is satisfied (S115). Then, when the condition of I>N is satisfied, the value of I is set to N (S120). On the other hand, when the condition of I>N is not satisfied, the process of Step S120 is skipped. Then, the PHY rate setting unit 134 sets the physical transfer rate to the physical transfer rate Rate_{phy}[I] of the correspondence table which corresponds to the value of I set at the current time point.

### 3. Second Embodiment

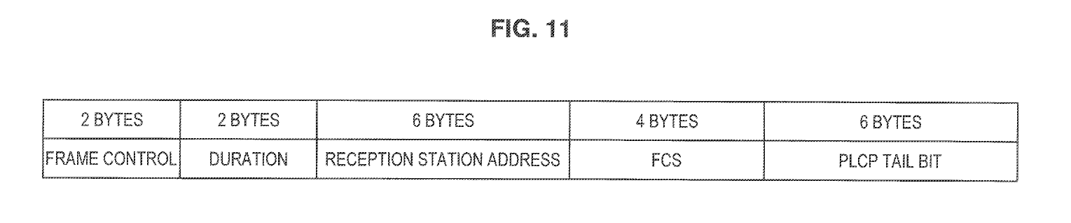

Next, a video transfer system according to a second embodiment of the present disclosure will be described with reference to FIG. 11. FIG. 11 is a descriptive diagram showing a configuration of an ACK packet transferred in the video transfer system according to the second embodiment of the present disclosure. The video transfer system described here has the configuration described in FIG. 2. The video transfer system according to the second embodiment is different from the video transfer system according to the first embodiment in that it performs re-transmission control of a data frame.

In the present embodiment, the video transmission device 100 waits for a response of an ACK frame from the video reception device 200 after transmitting a data frame. Then, the video transmission device 100 performs re-transmission of the data frame when the ACK frame is returned and then not transmitted due to occurrence of a collision or the like. Note that ACK here is an abbreviation for ACKnowledgement.

In the system in which re-transmission control is performed as above, transfer efficiency drops due to such re-transmission of a frame. Thus, the video transmission device 100 according to the same embodiment decides an encoding rate and a physical transfer rate taking the drop of transfer efficiency into consideration.

Note that, here, re-transmission control that uses an access control scheme based on CSMA/CA DCF generally used in unicast communication using the wireless LAN standard of 802.11a is set to be performed.

### [3-1. Setting of a Physical Transfer Rate]

When the video transmission device 100 transmits the data frame and the video reception device 200 correctly receives the data frame, the ACK frame is returned after an SIFS time. When the video reception device 200 is not capable of correctly receiving the data frame, the ACK frame is not returned to the video transmission device 100. The video transmission device 100 in this case detects non-reception after standing by for a DIFS time. Then, the video transmission device 100 increases a CW (Contention Window) according to the calculation formula below. The video transmission device 100 transmits the data frame again after a back-off time elapses.

CW=(CWₘᵢₙ+1)2ⁿ−1 Expression (4)

Here, n is the number of times of re-transmission. The wireless LAN-MAC unit 120 of the video transmission device 100 calculates the average number of times of re-transmission for one data frame per unit time (for example, at an interval of 10 seconds), and then supplies the average number of re-transmissions to the rate control unit 130. In consideration of the drop of transfer efficiency caused by the re-transmission of the data frame, the calculation of the TS packet effective rate using the average number of times of re-transmission n is as follows.

$$TS packet effective rate = \frac{TS packet length \times Number of TS packets}{\begin{matrix}( P L C P transfer time + Frame transfer time + DIFS ) \times \\ n + Total B O time + S I F S + A C K frame transfer time\end{matrix}} \qquad Expression ( 5 )$$

Here, the total BO time is a total of back-off times when the number of times of re-transmission is n.

Note that the ACK frame transfer time is calculated according to Expression (6) below.

$$A C K frame transfer time = [ \frac{A C K frame length}{Physical transfer rate} / O F D M symbol length ] \times O F D M symbol length \qquad Expression ( 6 )$$

Herein. FIG. 11 shows a format of the ACK frame. The ACK frame includes frame control of 2 bytes, duration of 2 bytes, a receiving station address of 6 bytes, FCS of 4 bytes, and PLCP tail bit of 6 bytes.

Here, a total of back-off times, i.e., a total BO time when the number of times of re-transmission is n, is calculated as follows.

Total BO time=CWₜₒₜₐₗ×Throttle time/2 Expression (7)

Here, CWₜₒₜₐₗ is the average value of the total of CW used when the number of times of re-transmission is n, and is calculated as follows using the formula of geometric progression.

$$\begin{matrix}{CW}_{total} = {\sum }_{k = 0}^{n} ( ( {CW}_{min} + 1 ) \cdot {2}^{k} - 1 ) \\ = {\sum }_{k = 0}^{n} ( {CW}_{min} + 1 ) \cdot {2}^{k} - ( n + 1 ) \\ = \frac{( {CW}_{min} + 1 ) ( 1 - {2}^{n + 1} )}{1 - 2} - ( n + 1 ) \\ = ( {CW}_{min} + 1 ) ( {2}^{n + 1} - 1 ) - n - 1\end{matrix} \qquad Expression ( 8 )$$

Using Expressions (5) to (8), the same correspondence table as that of FIG. 7 of the first embodiment can be generated. The physical transfer rate setting unit 134 can set a physical transfer rate through the operation described in the first embodiment using the correspondence table generated here.

### [3-2. Setting of an Encoding Rate]

In addition, in the present embodiment, an encoding rate can also be set according to the number of times of re-transmission. Herein, an example of TFRC-based encoding rate control using the average number of times of re-transmission will be shown. For example, the video transmission device 100 periodically acquires a packet loss rate on the reception side and an RTT by receiving an RR (Receive Ready) packet from the video reception device 200 using the RTCP.

When the rate control is started, a throughput is calculated using Expression (9) shown below as a slow-start phase.

X=2×X Expression (9)

Here, an initial value of X is a transmission packet size. When packet loss is detected from the RR packet, the phase is transitioned to a general congestion evasion phase.

$$X = \frac{s}{\begin{matrix}R T T \times \sqrt{\frac{2 bp}{3}} + \\ ( tRTO \times 3 \times \sqrt{\frac{3 bp}{8}} \times p \times ( 1 + 32 {p}^{2} ) )\end{matrix}} \qquad Expression ( 10 )$$

Here, s represents a transmission packet size, p represents a packet loss rate observed on the reception side, b represents the number of packets accepted by one ACK in the TCP, and tRTO represents a re-transmission time-out value. The throughput calculated in processes so far is the TFRC itself, but the encoding rate setting unit 132 further adds a process shown in Expression (11) below using the average number of times of re-transmission n.

$$X = \frac{α X}{n + 1} \qquad Expression ( 11 )$$

Here, α is a coefficient obtained through experimentation.

As described above, when re-transmission occurs in the video transfer system in which re-transmission control is performed, transfer efficiency drops due to re-transmission of frames. In this case, it is preferable to set the physical transfer rate and the encoding rate according to the drop of transfer efficiency. Thus, the physical transfer rate and the encoding rate herein are set again according to the number of times of re-transmission. Accordingly, a more appropriate physical transfer rate and encoding rate are set, and thus packet loss and a delay in buffering are reduced, transfer efficiency is enhanced, and QoE (Quality of Experience) improves.

Note that, in the video transfer system according to the second embodiment described above, a physical transfer rate is decided from an encoding rate, but the present technology is not limited thereto. An encoding rate may be decided from a physical transfer rate.

### 4. CONCLUSION

According to the video transfer system of each embodiment of the present disclosure described above, a physical transfer rate is correctly set in accordance with an encoding rate. In addition, cross-layer-associated rate control of deciding an encoding rate and a physical transfer rate at the same time can be combined.

Thus, effects such as enhancement in transfer efficiency, a reduction of packet loss, and a reduction of a delay in buffering are expected. In other words, it is highly likely that disarray of videos (videos not being smoothly reproduced) caused by a drop of transfer efficiency, an increase in packet loss, and an increase of a delay in buffering can be avoided, and thus the effect of improved QoE is expected.

Hereinabove, the preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

Note that, in the present specification, the steps described in the flowchart include processes performed in a time-series manner in the described order, as well as processes that are not necessarily performed in a time-series manner but may be executed in a parallel or individual manner. In addition, it is needless to say that, even for steps processed in a time-series manner, the order can be appropriately changed if necessary.

Additionally, the present technology may also be configured as below.

(1)

A video transmission device including:

an encoding unit configured to encode video data;

a transfer rate setting unit configured to set a transfer rate of a physical layer based on an encoding rate of the encoded video data; and

a transmission unit configured to transmit the encoded video data at the transfer rate.

(2)

The video transmission device according to (1),

wherein the transmission unit re-transmits the video data when packet loss occurs, and

wherein the transfer rate setting unit re-sets the transfer rate based on the number of times of re-transmission.

(3)

The video transmission device according to (2), further including:

an encoding rate setting unit configured to compute and set an encoding rate at which the video data is encoded from the transfer rate set based on the number of times of re-transmission.

(4)

The video transmission device according to (2), wherein the transfer rate setting unit sets the transfer rate of the physical layer substantially at the same timing as timing at which the encoding rate is set.

(5)

The video transmission device according to any of (1) to (4), wherein the transmission unit operates according to the standard of IEEE 802.11.

(6)

The video transmission device according to (1), wherein the transmission unit transfers the video data in multicast.

(7)

The video transmission device according to any of (1) to (6), wherein the transmission unit transfers the video data in unicast.

(8)

A video transmission method including:

encoding video data;

setting a transfer rate of a physical layer based on an encoding rate of the encoded video data; and

transmitting the encoded video data at the transfer rate.

(9)

A program for causing a computer to function as a video transmission device including

an encoding unit configured to encode video data.

a transfer rate setting unit configured to set a transfer rate of a physical layer based on an encoding rate of the encoded video data, and

a transmission unit configured to transmit the encoded video data at the transfer rate.

### REFERENCE SIGNS LIST

100 video transmission device
105 video input unit
110 encoding unit
115 packet generation unit
120 wireless LAN-MAC unit
125 wireless LAN-PHY unit
130 rate control unit
132 encoding rate setting unit
134 PHY rate setting unit
140 wireless antenna
200 video reception device
205 wireless antenna
210 wireless LAN-PHY unit
215 wireless LAN-MAC unit
220 packet processing unit
225 decoding unit
230 video processing unit
10 video source
20 display device

1. A video transmission device comprising:
an encoding unit configured to encode video data;
a transfer rate setting unit configured to set a transfer rate of a physical layer based on an encoding rate of the encoded video data; and
a transmission unit configured to transmit the encoded video data at the transfer rate.

2. The video transmission device according to claim 1,
wherein the transmission unit re-transmits the video data when packet loss occurs, and
wherein the transfer rate setting unit re-sets the transfer rate based on the number of times of re-transmission.

3. The video transmission device according to claim 2, further comprising:
an encoding rate setting unit configured to compute and set an encoding rate at which the video data is encoded from the transfer rate set based on the number of times of re-transmission.

4. The video transmission device according to claim 1, wherein the transfer rate setting unit sets the transfer rate of the physical layer substantially at the same timing as timing at which the encoding rate is set.

5. The video transmission device according to claim 1, wherein the transmission unit operates according to the standard of IEEE 802.11.

6. The video transmission device according to claim 1, wherein the transmission unit transfers the video data in multicast.

7. The video transmission device according to claim 1, wherein the transmission unit transfers the video data in unicast.

8. A video transmission method comprising:
encoding video data:
setting a transfer rate of a physical layer based on an encoding rate of the encoded video data; and
transmitting the encoded video data at the transfer rate.

9. A program for causing a computer to function as a video transmission device including
an encoding unit configured to encode video data,
a transfer rate setting unit configured to set a transfer rate of a physical layer based on an encoding rate of the encoded video data, and
a transmission unit configured to transmit the encoded video data at the transfer rate.
